(19) United States
(12) Patent Application Publication
(10) Pub. No.: US 2003/0218744 A1
(43) Pub. Date: Nov. 27, 2003

(54) Optical structures employing semicontinuous metal films

(76) Inventors: Vladimir M. Shalaev, West Lafayette, IN (US); Z. Charles Ying, Las Cruces, NM (US); Andrey K. Sarychev, Las Cruces, NM (US)

Correspondence Address: PEACOCK MYERS AND ADAMS P C, P O BOX 26927, ALBUQUERQUE, NM, 871256927

(21) Appl. No.: 09/955,712

(22) Filed: Sep. 19, 2001

Related U.S. Application Data
(60) Provisional application No. 60/233,804, filed on Sep. 19, 2000.
(60) Provisional application No. 60/278,466, filed on Mar. 23, 2001.

(51) Int. Cl. G01J 3/44

(52) U.S. Cl. 356/301

(57) ABSTRACT

An optical sensing enhancing material comprising a medium, the medium comprising a semicontinuous metal film of randomly distributed metal particles and their clusters at approximately their percolation threshold. The medium preferably additionally comprises a microcavity/microresonator. Also devices and methods employing such material.

### CROSS-REFERENCE TO RELATED APPLICATIONS

This application claims the benefit of the filing of U.S. Provisional Patent Application Serial No. 60/233,804, entitled “Optical Recording and Limiting, Enhanced Photochemistry, Photobiology, Super-Sensitive Spectroscopy, Microlasers, Optical Switches and Amplifiers Using Semicontinuous Metal Films and Microresonators,” filed on Sep. 19, 2000, and of U.S. Provisional Patent Application Serial No. 60/278,466, entitled “Identification of Enantiomers Using Semicontinuous Metal Films,” filed on Mar. 23, 2001, and the specifications thereof are incorporated herein by reference.

### GOVERNMENT RIGHTS

The U.S. Government has a paid-up license in this invention and the right in limited circumstances to require the patent owner to license others on reasonable terms as provided for by the terms of Contract No. NAG8-1710 awarded by the U.S. National Aeronautics and Space Administration (NASA) and of Contract No. DMR-9810183 awarded by the U.S. National Science Foundation (NSF).

### BACKGROUND OF THE INVENTION

1. Field of the Invention (Technical Field)

The present invention relates to optical methods and structures employing semicontinuous metal films and microresonator/semicontinuous-metal-film composites.

2. Background Art

Note that the following discussion refers to a number of publications by author(s) and year of publication, and that due to recent publication dates certain publications are not to be considered as prior art vis-a-vis the present invention. Discussion of such publications herein is given for more complete background of the scientific principles and is not to be construed as an admission that such publications are prior art for patentability determination purposes.

For purposes of the specification and claims, a semicontinuous metal film, also called a random metal-dielectric film, is a thin film comprising randomly distributed metal particles and their clusters at or near the percolation (conductivity) threshold. The percolation threshold is defined as the metal filling factor p_{c} at which the metal-dielectric film experiences a transition from an insulator to a conductor, with respect to the DC electric current. Semicontinuous metal films can be grown on top of a dielectric or semiconductor substrate. A metal film reaches its percolation threshold where there exists a continuous conducting path between two opposite ends of the film. A metal film developed at or near its percolation threshold is semicontinuous, in contrast to discontinuous films at much lower metal-filling factors and continuous films at much higher metal-filling factors.

Surface-plasmon excitations in a semicontinuous metal film are localized in small nanometer-scale volumes, called hot spots. V. M. Shalaev, Nonlinear Optics Of Random Media: Fractal Composites and Metal-Dielectric Films (Springer Verlag, Berlin, December 1999); A. K. Sarychev and V. M. Shalaev, Physics Reports 335, p. 275 (September 2000); S. Grésillon, et al., Phys. Rev. Lett. 82, p. 4520 (May 1999); A. K. Sarychev, et al., Phys. Rev. B 60, p. 16389 (December 1999); V. M. Shalaev, et al., Phys. Rev. B 57, p. 13265 (May 1998); A. K. Sarychev, et al., Phys. Rev. E 59, p. 7239 (June 1999). The electromagnetic energy is concentrated in the hot spots, leading to the local optical intensity that can exceed the intensity of the incident light beam by four to five orders of magnitude, i.e., by a factor up to 100,000. The very intense local fields in the hot spots, with dimensions of approximately 10 nm, result in dramatically enhanced linear and, especially, nonlinear optical responses. While a linear optical response is proportional to light intensity, a nonlinear optical response is scaled with the square, cube or even higher power of light intensity and, therefore experiences a larger enhancement.

A semicontinuous metal film provides enhanced linear and nonlinear optical responses as long as its metal-filling factor p satisfies the condition of |p−p_{c}|≦(ε_{dielectric}/|εₘₑₜₐₗ|)^{l/(t+s)}, where p_{c} is the metal-filling factor at the percolation threshold, ε_{dielectric} is the dielectric function (i.e., permittivity) of the dielectric component of the semicontinuous metal film, and εₘₑₜₐₗ is the dielectric function of the metal component of the film. For a three-dimensionally semicontinuous metal film, t=2.05 and s=0.76 so that the exponent 1/(t+s)=0.356. For a very thin semicontinuous metal film, which can be viewed approximately as two dimensional, t=s=4/3 so that the exponent 1/(t+s)=0.375, which is quite close to the three-dimensional value of 0.356. For the purpose of defining the applicable range of a semicontinuous metal film for enhancing optical responses, the metal-filling factor p of the film should be within a range between p_{c}−(ε_{dielectric}/|εₘₑₜₐₗ|)^{0.36} and p_{c}+(ε_{dielectric}/|εₘₑₜₐₗ|)^{0.36}.

The following patents are illustrative of the prior art, albeit not disclosing use of semicontinuous metal films: U.S. Pat. No. 6,017,630 discloses forming ultrafine particles on a substrate by directing a slanting high energy irradiating beam against side walls of a plurality of pores in a target material. U.S. Pat. Nos. 5,817,410, 4,448,485, 5,401,569, 5,472,777, and 5,113,473 relate to isolated (i.e., independent) particles. U.S. Pat. Nos. 4,583,818, 6,122,091, 5,991,488, 5,067,788, 6,034,809, and 5,858,799 relate to continuous films. Additionally, periodic arrangements, different from random distribution of metal clusters in semicontinuous metal films, are disclosed in U.S. Pat. Nos. 4,583,818, 4,448,485, and 5,113,473.

### SUMMARY OF THE INVENTION (DISCLOSURE OF THE INVENTION)

The present invention is of an optical enhancing material comprising a medium, the medium comprising a semicontinuous metal film of randomly distributed metal particles and their clusters at approximately their percolation threshold. In the preferred embodiment, the metal comprises at least one metal selected from silver, gold, copper, platinum, nickel, and aluminum. The metal particles have an average width between approximately 1 and 1000 nanometers. The metal particles and their clusters have lengths varying from the widths of individual metal particles to a lateral size of the metal film. The semicontinuous metal film has an average thickness between approximately 1 and 100 nanometers. The semicontinuous metal film has a metal-filling factor p over a range between p_{c}−(ε_{dielectric}/|εₘₑₜₐₗ|)^{0.36} and p_{c}+(ε_{dielectric}/|εₘₑₜₐₗ|)^{0.36}, where p_{c} is a metal-filling factor at the percolation threshold, ε_{dielectric} is a dielectric function, permittivity, of a dielectric component of the semicontinuous metal film, and εₘₑₜₐₗ is a dielectric function, permittivity, of a metal component of the semicontinuous metal film. The semicontinuous metal film is manufactured via at least technique from ion exchange, thermal evaporation, pulsed laser deposition, laser ablation, electron-beam deposition, ion-beam deposition, sputtering, radio-frequency glow discharge, and lithography. The material provides optical enhancement at light wavelengths between approximately 10 and 100,000 nanometers, most preferably between approximately 200 and 20,000 nanometers. An analyte may be placed proximate the medium, such as at least one of the following: atoms, molecules, nanocrystals, nanoparticles, and biological materials. The analyte can be chiral. A non-reactive surface coating may be placed over the analyte, the medium, or both. The material may additionally comprise a microcavity/microresonator made of one or more materials selected from dielectric and semiconductor materials. The microcavity may be a sphere, a deformed sphere, a spheroid, a rod, or a tube. The microcavity may be a semiconductor laser cavity. The medium may be located at one or more surfaces of the microcavity (inner and/or outer surfaces). The medium may be an integrated component of the microcavity.

The invention is also of an optical sensor comprising: a medium, the medium comprising a semicontinuous metal film of randomly distributed metal particles and their clusters at approximately their percolation threshold; a light source incident on the medium; and one or more detectors of light emitted from the medium. In the preferred embodiment, the detector detects at least one signal selected from fluorescence, spontaneous emission, Raman scattering, Rayleigh scattering, Brillouin scattering, and/or nonlinear optical processes selected from the group consisting of stimulated Raman scattering, hyper-Raman scattering, hyper-Rayleigh scattering, multi-photon anti-Stokes emission, harmonic generation, sum-frequency generation, difference-frequency generation, optical parametric processes, multi-photon absorption, three- and four-wave mixing, and phase conjugation. The optical sensor may additionally comprise a microcavity/microresonator.

The invention is additionally of an optical sensing method comprising the steps of: providing a doped medium, the medium comprising a semicontinuous metal film of randomly distributed metal particles and their clusters at approximately their percolation threshold; locating the doped medium proximate a medium; exciting the doped medium with a light source; and detecting light emitted from the doped medium. In the preferred embodiment, detecting comprises detecting at least one signal selected from: fluorescence, spontaneous emission, Raman scattering, Rayleigh scattering, Brillouin scattering, and/or nonlinear optical processes selected from the group consisting of stimulated Raman scattering, multi-photon anti-Stokes emission, hyper-Raman scattering, hyper-Rayleigh scattering, harmonic generation, sum-frequency generation, difference-frequency generation, optical parametric processes, multi-photon absorption, three- and four-wave mixing, and phase conjugation. A microcavity/microresonator may be employed in an additional step.

The invention is further of a method of detecting an analyte material, comprising: exciting both the analyte material and a medium in a vicinity of the analyte material, the medium comprising a semicontinuous metal film of randomly distributed metal particles and their clusters at approximately their percolation threshold, with at least one light source; and detecting light emitted from the material and medium. In the preferred embodiment, detecting comprises detecting at least one signal selected from: fluorescence, spontaneous emission, Raman scattering, Rayleigh scattering, Brillouin scattering, and/or nonlinear optical processes selected from the group consisting of stimulated Raman scattering, multi-photon anti-Stokes emission, hyper-Raman scattering, hyper-Rayleigh scattering, harmonic generation, sum-frequency generation, difference-frequency generation, optical parametric processes, multi-photon absorption, three- and four-wave mixing, and phase conjugation. A microcavity/microresonator may be employed in an additional step. The analyte material is preferably selected from: atoms; molecules (including but not limited to chiral molecules); nanoparticles; chemical agents in water and atmosphere; biological agents in water and atmosphere; contaminations and environment hazards in the air, in water, in soil, at or near manufacturing sites, or at waste dumps; explosives; controlled substances; residual chemicals in foods; food poison; and chemical and biological agents in a body, bodily fluids, and wastes of humans and animals.

The invention is yet further of a gratingless spectrometer comprising: a medium, the medium comprising a semicontinuous metal film of randomly distributed metal particles and their clusters at approximately their percolation threshold; a light source incident on the medium; and one or more near-field detectors of light emitted from the medium. The medium can also include a microcavity/microresonator along with semicontinuous metal film.

The invention is still further of a gratingless spectroscopy method comprising: providing a medium, the medium comprising a semicontinuous metal film of randomly distributed metal particles and their clusters at approximately their percolation threshold; exciting the medium with a light source; and detecting light emitted from the doped medium in the near-field zone. The medium can also include a microcavity/microresonator along with semicontinuous metal film.

The invention is additionally of a device for cryptography, coding and decoding information comprising: a medium, the medium comprising a semicontinuous metal film of randomly distributed metal particles and their clusters at approximately their percolation threshold; a light source incident on the medium; one or more near-field detectors of light emitted from the medium; and a logic component that compares a detected light pattern with an expected pattern. The medium can also include a microcavity/microresonator along with semicontinuous metal film.

The invention is also of a method for cryptography, coding and decoding information comprising: providing a medium, the medium comprising a semicontinuous metal film of randomly distributed metal particles and their clusters at approximately their percolation threshold; exciting the medium with a light source; detecting light emitted from the medium in the near-field zone; and comparing a detected light pattern with an expected pattern. The medium can also include a microcavity/microresonator along with semicontinuous metal film.

The invention is further of an enhanced optical limiting material and device comprising: a medium, the medium comprising a semicontinuous metal film of randomly distributed metal particles and their clusters at approximately their percolation threshold; and an optical limiting material placed proximate the medium.

The invention is yet further of a microlaser comprising: a medium, the medium comprising a semicontinuous metal film of randomly distributed metal particles and their clusters at approximately their percolation threshold; an optically active material; a light source incident on the medium and the optically active material; and a microcavity.

The invention is still further of an optical amplifier comprising: a medium, the medium comprising a semicontinuous metal film of randomly distributed metal particles and their clusters at approximately their percolation threshold; and a light source incident on the medium. In the preferred embodiment, the optical amplifier additionally comprises a layer of coating material selected from molecules, nanocrystals, and nanoparticles placed proximate the medium. The optical amplifier preferably additionally comprises a microcavity/microresonator.

The invention is also of an optical amplification method comprising: providing a medium, the medium comprising a semicontinuous metal film of randomly distributed metal particles and their clusters at approximately their percolation threshold; providing an input signal; and exciting the medium with a light source. In the preferred embodiment, a layer of coating material selected from molecules, nanocrystals, and nanoparticles is placed proximate the medium. A microcavity/microresonator is also preferably provided.

The invention is additionally of an optical switch comprising: a medium, the medium comprising a semicontinuous metal film of randomly distributed metal particles and their clusters at approximately their percolation threshold; and a light source incident on the medium. In the preferred embodiment, a layer of optical switching material selected from molecules, nanocrystals, and nanoparticles is placed proximate the medium. A microcavity/microresonator is also preferably provided.

The invention is further of an optical switching method comprising: providing a medium, the medium comprising a semicontinuous metal film of randomly distributed metal particles and their clusters at approximately their percolation threshold; providing an input signal; and exciting the medium with a light source. In the preferred embodiment, a layer of coating material selected from molecules, nanocrystals, and nanoparticles is placed proximate the medium. A microcavity/microresonator is also preferably provided.

The invention is yet further of a super density optical recording device comprising: a medium, the medium comprising a semicontinuous metal film of randomly distributed metal particles and their clusters at approximately their percolation threshold; a layer of photosensitive materials placed proximate the medium; a light source incident on the medium; and one or more near-field detectors of light emitted from the medium and the layer of photosensitive materials.

The invention is still further of a super density optical recording method comprising: providing a medium, the medium comprising a semicontinuous metal film of randomly distributed metal particles and their clusters at approximately their percolation threshold; providing a layer of photosensitive materials placed proximate the medium; exciting the medium and photosensitive materials with a light source; and detecting light emitted from the medium and photosensitive materials in a near-field zone.

The invention is also of a photochemical enhancing device comprising: a medium, the medium comprising a semicontinuous metal film of randomly distributed metal particles and their clusters at approximately their percolation threshold; and a photochemical agent placed proximate the medium. In the preferred embodiment, there may be an additional component comprising a highly porous dielectric matrix.

The invention is additionally of a photochemical enhancing method comprising: providing a medium, the medium comprising a semicontinuous metal film of randomly distributed metal particles and their clusters at approximately their percolation threshold; providing a photochemical agent placed proximate the medium; and exciting the medium and photochemical agent with a light source. In the preferred embodiment, there may be an additional step of providing a highly porous dielectric matrix.

The invention is further of a photobiological enhancing device comprising: a medium, the medium comprising a semicontinuous metal film of randomly distributed metal particles and their clusters at approximately their percolation threshold; and a photobiological agent placed proximate the medium. In the preferred embodiment, there may be an additional component comprising a highly porous dielectric matrix.

The invention is yet further of a photobiological enhancing method comprising: providing a medium, the medium comprising a semicontinuous metal film of randomly distributed metal particles and their clusters at approximately their percolation threshold; providing a photobiological agent placed proximate the medium; and exciting the medium and photobiological agent with a light source. In the preferred embodiment, there may be an additional step of providing a highly porous dielectric matrix.

The invention is further of sub-femtosecond pulse generation device comprising: a medium, the medium comprising a semicontinuous metal film of randomly distributed metal particles and their clusters at approximately their percolation threshold; a light source, selected from the group of femtosecond pulses and white-light, incident on said medium; and one or more near-field detectors of light emitted from said medium.

The invention is yet further of a method of sub-femtosecond pulse generation comprising: providing a medium, the medium comprising a semicontinuous metal film of randomly distributed metal particles and their clusters at approximately their percolation threshold; exciting the medium with a light source selected from the group of femtosecond pulses and white-light; and detecting the sub-femtosecond pulses using one or more near-field detectors.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is an electron microscopy image (400×500 nm) of a semicontinuous metal film near percolation;

FIG. 2 is a near-field optical image (5×5 μm) of a semicontinuous metal film near the percolation threshold; the white areas have much greater local light intensity than the dark areas;

FIG. 3 is a schematic representation of an optical sensor employing a semicontinuous metal film (one or more detectors may be used);

FIG. 4 is a schematic representation of a gratingless spectrometer employing a semicontinuous metal film (one or more near-field detectors may be used);

FIG. 5 is a schematic representation of a device for cryptography, coding and decoding information employing a semicontinuous metal film (one or more near-field detectors may be used);

FIG. 6 is a schematic representation of an enhanced optical limiting device employing a semicontinuous metal film;

FIG. 7 is a schematic representation of a microlaser employing a semicontinuous metal film; the film can be either (A) located at the surface of a microcavity or (B) integrated together with the microcavity; there is an optically active material (not shown), which could stand alone or be integrated together with either the semicontinuous metal film or microcavity; the energy source may be either optical or electrical;

FIG. 8 is a schematic representation of an optical amplifier employing a semicontinuous metal film; the amplifier (A) may or (B) may not have an additional coating layer of optical materials such as Raman materials; the output is preferably amplified;

FIG. 9 is a schematic representation of an optical switch employing a semicontinuous metal film; the switch (A) may or (B) may not have an additional coating layer of optical materials such as Kerr materials; the input and output are at different wavelengths;

FIG. 10 is a schematic representation of a super-density optical recording device employing a semicontinuous metal film (one or more near-field detectors may be used);

FIG. 11 is a schematic representation of a photochemical enhanced device employing a semicontinuous metal film;

FIG. 12 is a schematic representation of a photobiological enhanced device employing a semicontinuous metal film; and

FIG. 13 is a schematic representation of a sub-femtosecond pulse generation device employing a semicontinuous metal film.

The figures adopt the following reference numerals: 10, a medium comprising a semicontinuous metal film of randomly distributed metal particles and their clusters; 12, a light source; 14, a detector located at the same side of the light source; 16, an alternative detector located at the opposite side of the light source; 18, additional layer or layers for structural support and other purposes; 24, a near-field detector located at the same side of the light source; 26, an alternative near-field detector located at the opposite side of the light source; 32, a computerized logic component that compares a detected light pattern with an expected pattern; 42, a layer of optical limiting materials; 52, a microcavity; 54, an energy source; 62, a layer of optical materials such as Raman materials; 64, a layer of optical materials such as Kerr materials; 66, a layer of photosensitive materials; 72, a photochemical agent; 82, a photobiological agent; and 92 a light source selected from the group of femtosecond pulses and white-light.

The detectors 14, 16, 24, 26 may contain polarization selection components (e.g., polarizers), or wavelength discrimination components (e.g., spectrometers), or both polarization selection and wavelength discrimination components.

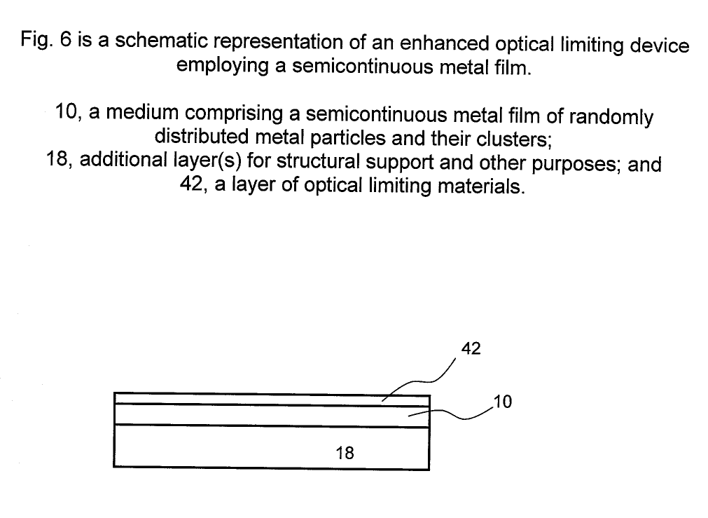

The optical layers 42, 62, 64, 66, 72, 82 may be located on top of the semicontinuous metal films 10 as shown in FIGS. 6 and 8-12, located under the semicontinuous metal films, or mixed together with the semicontinuous metal films.

### DESCRIPTION OF THE PREFERRED EMBODIMENTS (BEST MODES FOR CARRYING OUT THE INVENTION)

The present invention is of a preferred method of fabricating semicontinuous metal films and also of applications and optical methods for structures comprising semicontinuous metal films.

Semicontinuous metal films are preferably produced by depositing metal atoms and/or ions onto insulator or semiconductor substrate, especially those types of substrate where the metal does not “wet.” In the preferred deposition process, small and isolated metal islands are formed first. As the metal coverage increases, the islands coalesce, forming irregularly shaped clusters in random geometry on the substrate. The cluster size increases as the film grows further and diverges as the film approaches the percolation threshold, where an insulator-to-metal transition occurs. A metal film at or near its percolation threshold is semicontinuous. A quasi-continuous film, with voids of irregular shapes, is formed at a metal coverage substantially higher than the percolation threshold.

Metal deposition can be realized using physical or chemical methods. The former comprises thermal evaporation, pulsed laser deposition, electron-beam deposition, ion-beam deposition, sputtering, radio-frequency glow discharge, and lithography. The lithography may use uv light, x-ray, an electron beam, or an ion beam. An example of chemical methods is ion exchange. The average metal coverage can be measured using a quartz film-thickness measurement device. The percolation threshold can be determined accurately and reproducibly using electric and/or optical methods. At the percolation threshold, the DC electric conductivity increases sharply and light transmittance, absorption and reflection exhibit anomalous behavior. A. K. Sarychev and V. M. Shalaev, Physics Reports 335, p. 275 (September 2000). Morphology of semicontinuous metal films can be characterized using electron microscopy and/or atomic force microscopy.

Depending on (a) choice of metal, (b) choice of dielectric or semiconductor substrate, and (c) growth conditions, the average thickness of the film may vary from 0.1 to 100 nm while the average width of the metal cluster branches in the surface plane may vary from 1 to 1000 nm, and the lengths of the metal cluster branches in the surface plane vary widely from the lateral width of the metal cluster branches to the size of the whole film. A typical value for film thickness is 5 to 10 nm; and a typical lateral width of metal particles is somewhat larger (10 to 50 nm). The space between the metal clusters can be filled with a dielectric or semiconductor material, or left unfilled. Filling the space between the metal clusters with a dielectric or semiconductor material leads to a smoother top surface of the film. Covering the whole film with a thin layer of a dielectric, semiconductor, or organic material smoothens the film's top surface and protects the metal from chemical reactions and degradation.

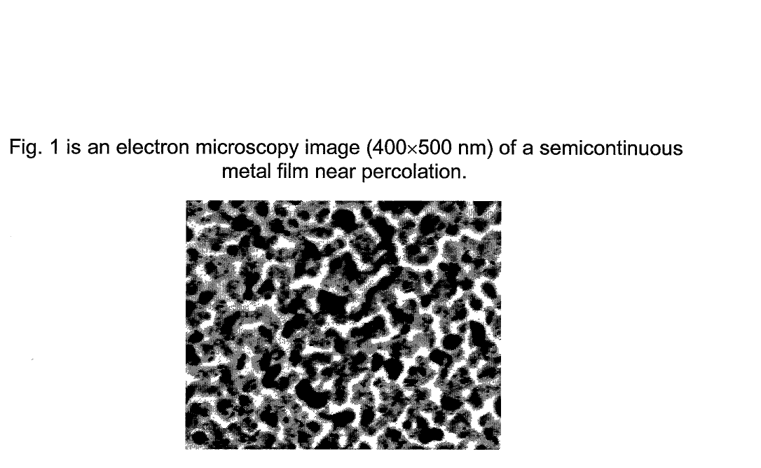

FIG. 1 shows an electron microscopy image (top view) of a semicontinuous metal film fabricated using a pulsed laser deposition (PLD) technique. In the fabrication process, a silver target was placed in a vacuum chamber back-filled with argon, which acted as a buffer gas. A nanosecond Nd:YAG laser was used as the light source. Silver atoms, ions and small clusters ejected from the silver target surface by laser irradiation were deposited onto a glass or other substrate placed near the silver target. The dark features in the image above represent clusters of metal (silver in this case). The white areas are voids. This particular film appears very close to the percolation threshold.

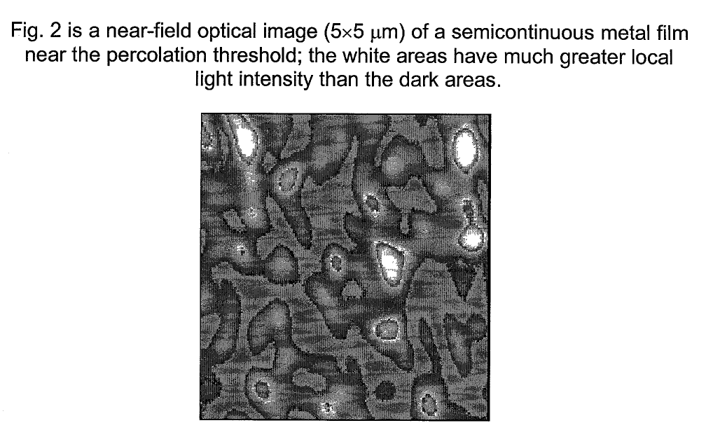

The local field at a semicontinuous metal film can be detected employing near-field optical method (M. A. Paesler and P. Moyer, Near-Field Optics: Theory, Instrumentation, and Applications (Wiley, New York, 1996)). The near-field optical instrument may use tapped optical fiber (straight or bent), sharpened metal wire, solid immersion lens and other technologies. FIG. 2 shows a near-field optical image of a semicontinuous silver metal film near the percolation threshold. The white areas have much greater local light intensity than the dark areas.

While both semicontinuous metal films and fractal aggregates of metal nanoparticles provide enhancement of local optical fields, they have different geometries and different properties. Semicontinuous metal films have several technical advantages over fractal aggregates of metal nanoparticles, especially those made in a chemical way. (a) Semicontinuous metal films are made under vacuum with well-controlled environment and parameters, leading to better quality control. (b) The real-time and in-situ determination of percolation threshold can be achieved accurately and reproducibly using electric and/or optical methods. (c) The structure of a semicontinuous metal film, being a network of highly interconnected metal clusters, is more robust than a fractal aggregate of metal nanoparticles, being a collection of loosely linked nanoparticles. (d) A semicontinuous metal film near the percolation threshold has, on average, a higher density and a more uniform distribution of hot spots than a fractal aggregate of metal nanoparticles. This result is associated with the fact that a semicontinuous metal film has roughly equal metal and insulator areas of uniform distribution on average, while a fractal aggregate has a number of voids of large and small areas. (e) Deposition of a semicontinuous metal film onto the surface of any substrate or a device is straightforward, simply by placing the substrate or device in a deposition chamber.

Combining the energy-concentrating effect in semicontinuous metal films with other means for producing strong resonances can result in truly gargantuan local fields. For example, morphology-dependent resonances (MDRs) in dielectric or semiconductor microcavities (or microresonators) produce large intensity enhancements in the resonances that can lead to lasing. R. K. Chang and A. J. Campillo, eds, Optical Processes in Microcavities (World Scientific, Singapore, 1996). These resonances have extremely high quality factors (Q=10⁵ to 10¹⁰) that result from confinement of the radiation within the microcavities by multiple total internal reflections. Light emitted or scattered from a source at the microcavity may couple to the high-Q MDRs in its spectral bandwidth, leading to enhancement of the spontaneous and/or stimulated optical emissions. Hence, coating microresonators with semicontinuous metal films will further increase, multiplicatively, the local fields leading to enhancement of optical and other photoinduced processes.

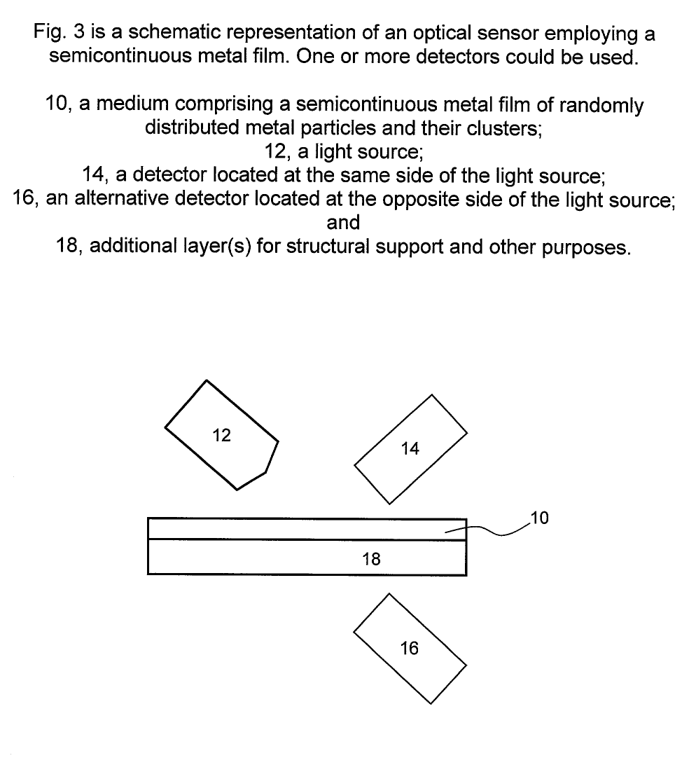

For example, FIG. 3 shows an optical sensor according to the invention which employs a semicontinuous metal film. The sensor preferably comprises a medium 10 comprising a semincontinuous metal film of randomly distributed metal particles and their clusters, a light source 12, one or more detectors 14 located at the same side of the medium as the light source, and an additional layer 18 for structural support and other purposes. The sensor optionally comprises one or more detectors 16 located at the opposite side of the medium from the light source.

Microcavities are optical resonators, with many possible shapes and dimensions. Examples of microcavity shapes include sphere, ellipsoid, polyhedron, and cylinders of various cross sectional geometry such as circle, ellipse, bow-tie and polygon. R. K. Chang, et al., eds., Optical Processes in Microcavities (World Scientific, Singapore, 1996); E. Gornik, Science 280, p. 1544 (1998). Microcavities can be either solid (e.g., a solid sphere) or hollow (e.g., a cylindrical tube). A solid spherical microcavity or a cylinder of circular cross section has quite uniform distribution of electric field. A cylinder of deformed circular or bow-tie cross section allows light emission in narrow angles. Optical fiber can be treated as a microcavity of cylindrical shape of circular cross section.

The three dimensions of a microcavity need not be the same. Usually at least one of the three dimensions of a microcavity is equal or greater than one half of the light wavelength of interest and at least one of the three dimensions is smaller than 1000 times of the light wavelength.

Semicontinuous metal films can be deposited onto the outer surface of a microcavity simply by placing the microcavity in a deposition chamber.

The present invention also has applications in conjunction with chiral molecules. A number of molecules, especially organic molecules and biomolecules, are chiral. Chiral molecules have two enantiomers (also named stereoisomers) with different handedness. The molecules that produce clockwise rotation of linearly polarized light are called positive (+) or dextrorotatory (d), while the molecules that produce counter clockwise rotation of linearly polarized light are called negative (−) or levorotatory (I). An alternative notation system for chiral molecules is based on geometric arrangement of the substituents of a chiral molecule. A chiral molecule is in the rectus (R) configuration if, with the lowest-ranked substituent pointing away, the order of decreasing precedence of the three highest-ranked substituents is clockwise. Otherwise, it is in the sinister (S) configuration.

A classical example of chiral organic molecules is bromochlorofluoromethane (BrCIFCH). In the biological systems on the Earth, the d enantiomer of sugars and the I enantiomer of amino acids dominate.

While the usual physical properties such as mass, density, melting temperature are identical for both enantiomers of a chiral material, enantiomers can have striking differences in their properties that depend on the arrangement of the atoms in space. Two enantiomers cause rotation of linearly polarized light in different directions. Biologically, (I)-nicotine, for example, is much more toxic than (d)-nicotine, and (I)-adrenaline is less active in the construction of blood vessels than (d)-adrenaline. (I)-Thyroxine is an amino acid of the thyroid gland, which speeds up metabolism and causes nervousness and loss of weight, while (d)-thyroxine exhibits none of these effects but is used to lower cholesterol level of patients.

There are over 500 chiral substances that are produced synthetically and used as prescription and over-the-counter drugs. Most of them are synthesized and administered as racemic mixtures even thought the desired therapeutic activity resides usually in one of the enantiomers. For example, the S enantiomer is responsible for the pain relief of ibuprofen, which is normally sold as a racemic mixture. Several antihistamine drugs, including Allegra®, Claritin® and Zyrtec®, have one of the enantiomers providing the desired therapeutic benefits of allergy treatment while the other causes side effects. When the racemic mixture of thalidomide was used in Europe four decades ago as a sedative and antinausea drug, due to (R)-thalidomide, the S enantiomer in the drug led to many cases of serious birth defects in children born to women who took the drug while pregnant.

The local fields in the hot spots exhibit optical activities; the locations of hot spots for a given semicontinuous metal film, when irradiated by light of different helicities (i.e., right- and left-elliptically or circularly polarized light), are usually different. The effect occurs because resonant plasmon modes in semicontinuous metal films, which have neither center nor plane of symmetry, have handedness in spatial distribution of their amplitudes. In contrast to chiral molecules, where the chiral substituents are usually much smaller than the light wavelength, the local chiral structures supporting localized plasmon oscillations in semicontinuous metal films can be comparable in size with the wavelength, so that the optical activity in these films can be much greater than in chiral molecules.

The chirality of the local field at a semicontinuous metal film can be detected employing near-field optical method (M. A. Paesler and P. Moyer, Near-Field Optics: Theory, Instrumentation, and Applications (Wiley, New York, 1996)) with the film irradiated by light of different helicities. The near-field optical instrument may use tapped optical fiber (straight or bent), sharpened metal wire, solid immersion lens and other technologies.

Optical activity can be used to distinguish the enantiomers from each other, which is very important because the chemical, biological and therapeutic effects of the enantiomers are often very different. Different enantiomers respond to a hot spot of a given handedness differently. Use of semicontinuous metal films as media for optical activity measurements can achieve much higher sensitivity while at the same time using a much smaller quantity of sample than the traditional techniques. The semicontinuous metal films serve as amplifiers that enhance optical signal. It is believed that measurements can be performed at the single molecular level.

All current techniques of optical detections of chiral materials can be combined with semicontinuous metal films, which provide signal enhancement. These comprise of polarimetry, circular dichroism (both electronic circular dichroism and vibrational circular dichroism) and nonlinear optical circular dichroism (e.g., second harmonic generation circular dichroism).

The present invention thus offers a super-sensitive probe of chiral purity without using an enantiomer separation procedure (e.g., chiral chromatography). Such a probe will be beneficial in development, synthesis, and manufacture of chiral molecules of enantiomeric purity.

Industrial Applicability:

The invention is further illustrated by the following non-limiting examples.

### EXAMPLE 1

Super-Sensitive Optical Spectroscopy and Detection

Semicontinuous metal films or semicontinuous-metal-film/microcavity composites can be used for super-sensitive optical spectroscopy. Both linear and nonlinear optical processes are possible. Examples of linear optical processes include fluorescence, Raman scattering, Brillouin scattering. Examples of nonlinear optical processes include stimulated Raman scattering, hyper-Raman scattering, multi-photon anti-Stokes emission, harmonic generation, sum-frequency generation, difference-frequency generation, optical parametric processes, multi-photon absorption, three- and four-wave mixing, and phase conjugation. R. W. Boyd, Nonlinear Optics (Harcourt Brace, 1992). It is interesting to note that, in contrast to conventional situations, where fluorescence is typically quenched, the local-field enhancement on the semicontinuous metal films or semicontinuous-metal-film/microcavity composites is so large that the rate of the radiative channel is greater than a non-radiative energy transformation. Accordingly, fluorescence and other optical processes are not quenched but rather dramatically enhanced.

The highly enhanced linear and nonlinear optical processes allow super-sensitive optical spectroscopy of a large number of objects, which may include atoms, molecules, nanocrystals, nanoparticles, and biological materials. These include but are not limited to detection and spectroscopical analysis of contaminations and environment hazards in the air, in water, in soil, at or near manufacturing sites, or at waste dumps; explosives; controlled substances; residual chemicals in foods; chemical and biological agents (including but not limiting to metal ions, proteins, DNA, DNA fragments, antigens, antibodies, bacteria and viruses) in the body, various body fluids and wastes of human and animals. An object to be examined should be placed in contact with or in a close proximity of a semicontinuous metal film or semicontinuous-metal-film/microcavity composite. The giant enhancement offered by a semicontinuous metal film alone or by a combination of a semicontinuousmetal-film/microcavity composite makes possible of detection of chemical, biological and physical materials in a very minute quantity, possibly down to single molecular level.

The optical spectroscopy employs far-field and/or near-field optical methods. R. W. Boyd, Nonlinear Optics (Harcourt Brace, 1992); M. A. Paesler, et al., Near-Field Optics: Theory, Instrumentation, and Applications (Wiley, New York, 1996). The near-field instrument may use tapped optical fiber (straight or bent), sharpened metal wire, solid immersion lens and other technologies.

While the term of optical spectroscopy implies of optical measurements at multiple light wavelengths, detection of chemical, biological and physical materials can often be made using a single incident light wavelength. Therefore, semicontinuous metal films or semicontinuous-metal-film/microcavity composites can be used for super-sensitive optical detections of a large number of objects mentioned above, utilizing both linear and nonlinear optical processes and employing far-field and/or near-field optical methods. The ability of super-sensitive detection of minute-quantity materials is very important for areas such as chemical studies, environmental monitoring, DNA analysis, and express medical diagnostics.

Employing semicontinuous metal films and near-field optical methods, optical spectroscopy can be achieved using neither a grating nor a prism. The heart of an optical spectrometer used today is a grating, which consists of a large number of parallel and periodic grooves, or a prism made of a transparent material. The grating or prism disperses light of different wavelengths into different directions. A semicontinuous metal film directs light of different wavelengths into different locations of hot spots. Since the hot-spot locations of a given semicontinuous metal film at various light wavelengths and/or polarizations are predetermined, the film can be used to perform optical spectroscopy of unknown light sources. The recording can be achieved employing a near-field optical method of either scanning or imaging using a solid immersion lens. Such a gratingless spectrometer can be used for chemical studies, environmental monitoring, DNA analysis, and express medical diagnostics.

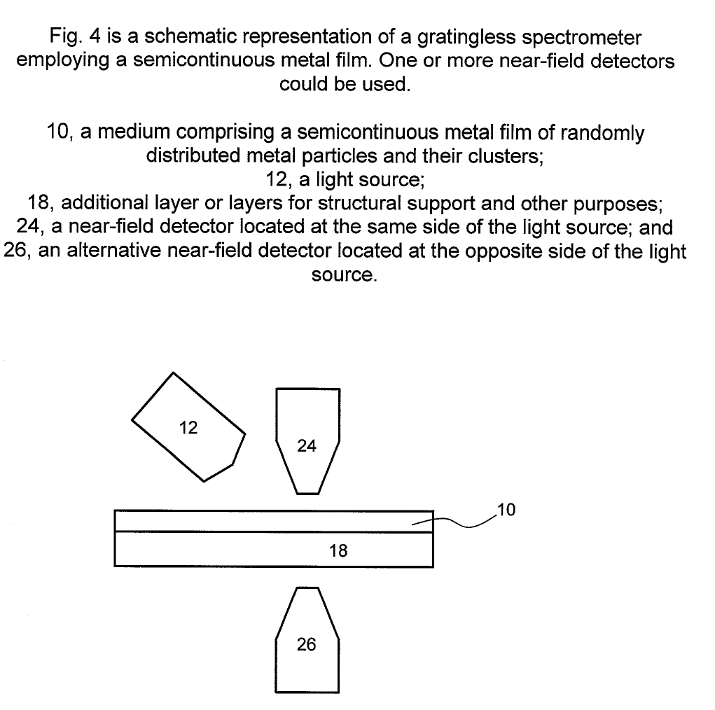

FIG. 4 illustrates a gratingless spectrometer employing a semicontinuous metal film according to the invention. The spectrometer preferably comprises a medium 10 comprising a semicontinuous metal film of randomly distributed metal particles and their clusters, a light source 12, an additional layer 18 for structural support and other purposes, and one or more near-field detectors 24 located on the same side of the medium as the light source. The spectrometer optionally comprises one or more near-field detectors 26 located on the opposite side of the medium from the light source.

### EXAMPLE 2

Coding and Decoding Information

A semicontinuous metal film can be also used as a device for writing and reading security codes and for cryptography. In this case, a match of a particular light source of single or multiple wavelengths at a particular polarization configuration and a particular pattern for a given semicontinuous metal film is required for the coding and positive identification. This is possible because a light with a given wavelength and polarization for any particular semicontinuous metal film induces unique field distribution, which practically cannot be reproduced with a different film and/or different light characteristics. This unique property can be used for secure coding, for example, in bank operations and in sending and processing secret information.

The advantages of optical detection using semicontinuous metal films or semicontinuous-metal-film/microcavity composites include super sensitivity, unique local field distribution, lower pumping power, smaller sizes, and lower weights than other designs.

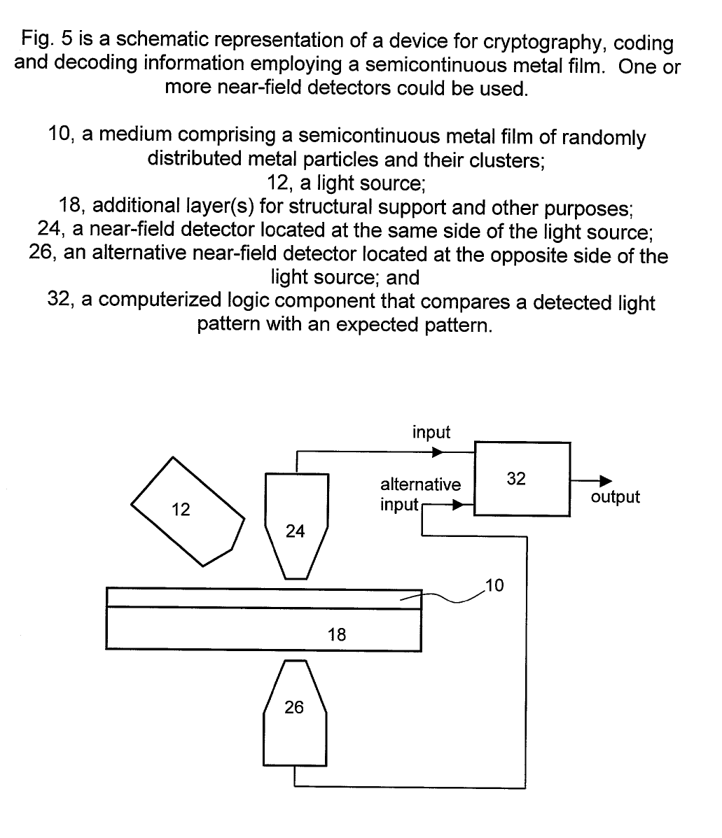

FIG. 5 illustrates a device for cryptography, coding, and decoding information employing a semicontinuous metal film according to the invention. The device preferably comprises a medium 10 comprising a semicontinuous metal film of randomly distributed metal particles and their clusters; a light source 12, one or more near-field detectors 24 located on the same side of the medium as the light source, and a computerized logic component 32 that compares a detected light pattern with an expected pattern. The device optionally comprises one or more near-field detectors 26 on the opposite side of the medium from the light source.

### EXAMPLE 3

Optical Limiting

Semicontinuous metal films can be used as media for optical limiting, which dramatically decreases light transmittance above a threshold of incident light intensity. There are a number of optical-limiting materials (e.g., molecules with reverse saturable absorption). R. Crane, et al., eds., Materials for Optical Limiting (Materials Research Society, Pittsburgh, 1995); P. Hood, et al., eds., Materials for Optical Limiting II (Materials Research Society, Pittsburgh, 1995). A mixture of semicontinuous metal film with traditional optical-limiting materials can dramatically increase sensitivity of such an optical limiter and decrease the operational threshold level.

FIG. 6 illustrates an enhanced optical limiting device employing a semicontinuous metal film according to the invention. The device preferably comprises a medium 10 comprising a semicontinuous metal film of randomly distributed particles and their clusters, an additional layer 18 for structural support and other purposes, and a layer of optical limiting materials 42.

### EXAMPLE 4

Microlasers

Semicontinuous metal films or semicontinuous-metal-film/microcavity composites can be used for microlasers. In order to achieve directional emission, a microcavity of a cylinder of deformed circular or bow-tie cross section allows laser emission in narrow angles. Another possibility is incorporation of semicontinuous metal films into semiconductor lasers, including the traditional semiconductor lasers and the recently developing Vertical Cavity Surface Emitting Lasers (VCSELs) in order to shift laser output wavelength and achieve laser output at multiple wavelengths. The advantages of microlasers with semicontinuous metal films or semicontinuous-metal-film/microcavity composites, which provide field enhancement, include lower pumping power, smaller sizes, and lower weights than other designs. Another important property of semicontinuous metal films that is important for their using for developing novel microlasers is their very broad amplification band, from the near ultra-violet to the far infrared.

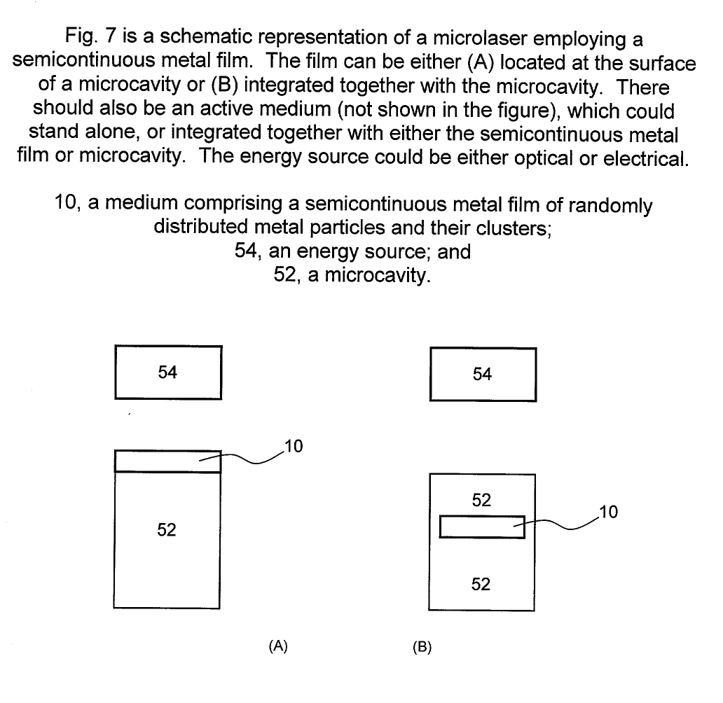

FIG. 7 illustrates a microlaser employing a semicontinuous metal film according to the invention. The microlaser preferably comprises a medium 10 comprising a semicontinuous metal film of randomly distributed metal particles and their clusters, an energy source 54, and a microcavity/microresonator 52. The film can be either (A) located at the surface of the microcavity or (B) integrated together with the microcavity. There is also an active medium (not shown), which could stand alone, or integrated together with either the semicontinuous metal film or microcavity. The energy source can be either optical or electrical.

### EXAMPLE 5

Optical Amplifiers and Switches

Semicontinuous metal films or semicontinuous-metal-film/microcavity composites can be used for super-sensitive optical amplification and switching, which utilize one or more of linear and nonlinear optical processes as mentioned above. Raman scattering, stimulated Raman scattering, and hyper Raman scattering are particularly suitable for optical amplification. The optical Kerr effect, with Femtosecond response time, is ideal for optical switching. The advantages of optical amplifiers and switches with semicontinuous metal films or semicontinuous-metal-film/microcavity composites include lower pumping power, smaller sizes, and lower weights than other designs.

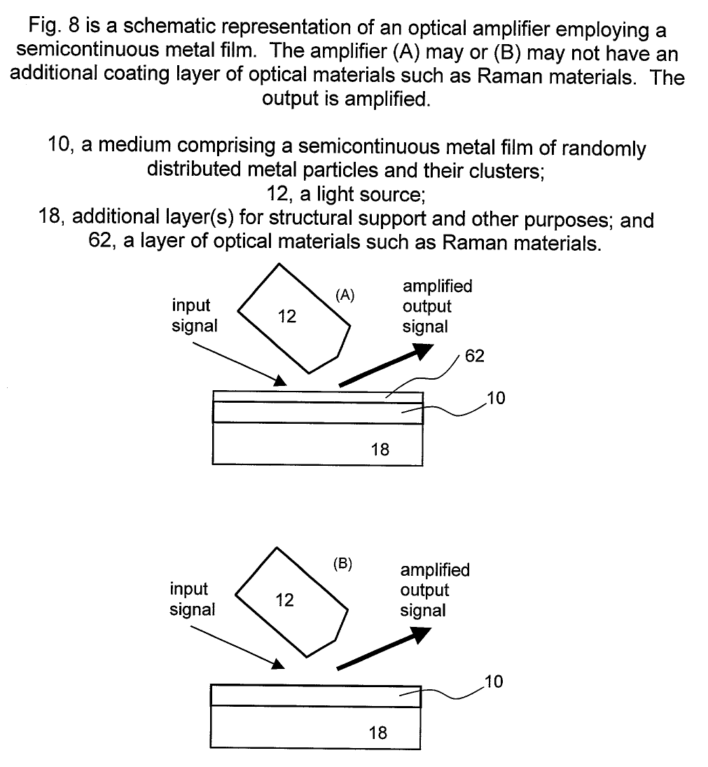

FIG. 8 illustrates an optical amplifier employing a semicontinuous metal film according to the invention. The optical amplifier preferably comprises a medium 10 comprising a semicontinuous metal film of randomly distributed metal particles and their clusters, a light source 12, an additional layer 18 for structural support and other purposes, and a layer of optical materials 62 such as Raman materials. The amplifier (A) may or (B) may not have an additional coating layer of optical materials such as Raman materials. The output is preferably amplified in comparison to the input.

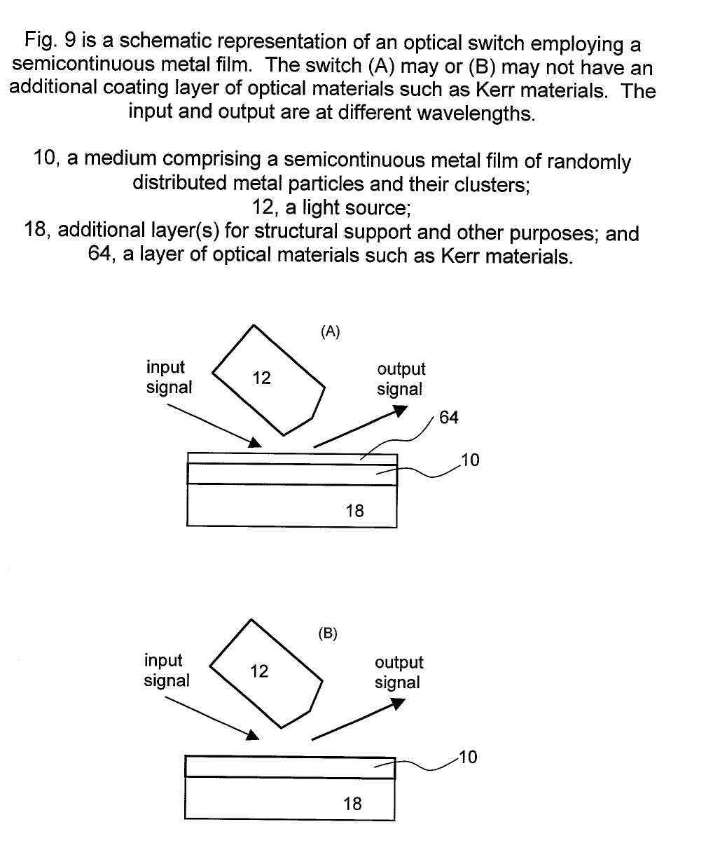

FIG. 9 illustrates an optical switch employing a semicontinuous metal film according to the invention. The optical switch preferably comprises a medium 10 comprising a semicontinuous metal film of randomly distributed metal particles and their clusters, a light source 12, an additional layer 18 for structural support and other purposes, and a layer of optical materials 64 such as Kerr materials. The amplifier (A) may or (B) may not have an additional coating layer of optical materials such as Kerr materials. The input and output are preferably at different wavelengths.

### EXAMPLE 6

Super-density Optical Recording

Semicontinuous metal films can be used as a medium for super-dense optical recording of information. The size of a hot spot is on the order of 10 nm. By varying the light wavelength and polarization of the incident beam one can excite any given spot of the size 10×10 nm². Adding one or more thin layers of a photosensitive material allowing optical recording of information, one can reach information density as large as 10¹² bit/cm², which is 1200 times greater than the density of DVD-9, single-sided double-layer DVD that holds 8.5 GB information.

Locations of hot spots at a semicontinuous metal film depend on light wavelength, polarization, and even angle of incidence. Use of multiple light wavelength, polarization, and/or angle of incidence allows several bits of information in the same area, effectively achieving multi-layer information storage.

All photosensitive materials that are currently in use or in investigation can be used together with semicontinuous metal films for super-dense optical recording. Examples of photosensitive materials include magneto-optic layers (e.g., TbFeCo), solid films exhibiting crystal-amorphous phase transitions (e.g., GeSbTe), dye molecules, and molecules with long life-time triplet states (e.g., polymers allowing the trans-cis photoisomerization). The semicontinuous metal layer increases the signal-noise ratio through hot spots, provides a natural patterning of the recording surface of ˜10 nm in dimensions, and allows storage of multiple bits of information in the same area.

Data reading and writing will employ near-field optical method. M. A. Paesler, et al., Near-Field Optics: Theory, Instrumentation, and Applications (Wiley, New York, 1996. The instrument may use tapped optical fiber (straight or bent), sharpened metal wire, solid immersion lens and other technologies.

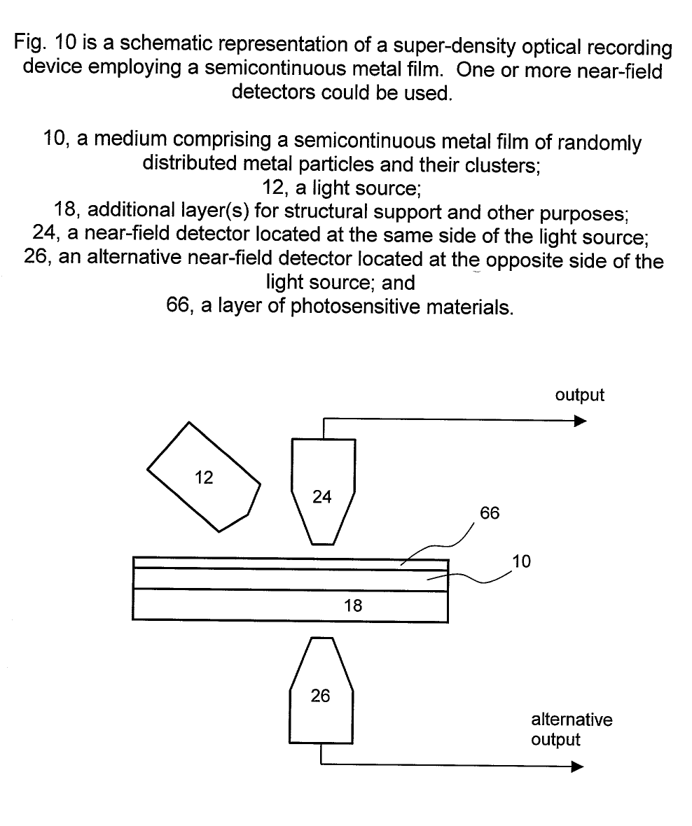

FIG. 10 illustrates a super-density optical recording device according to the invention using a semincontinuous metal film. The device comprises a medium 10 comprising a semicontinuous metal film of randomly distributed metal particles and their clusters, a light source 12, an additional layer 18 for structural support and other purposes, one or more near-field detectors 24 located on the same side of the medium as the light source, and a layer of photosensitive materials 66. The device optionally comprises one or more near-field detectors 26 located on the opposite side of the medium from the light source.

### EXAMPLE 7

Enhancement of Photochemistry and Photobiology

Semicontinuous metal films can also be used as media for enhancing photochemistry and photobiology. There are numerous chemical reactions and biological processes that are initiated or accelerated by light irradiation. N. J. Turro, Modern Molecular Photochemistry (Univ. Science Books, 1997); N. Serpone, et al., eds., Photocatalysis: Fundamentals and Applications (Wiley, New York 1989); E. Kohen, Photobiology (Academic Press, 1995). A classical example of photobiology is light absorption by chlorophyll, the biomolecule that initiates the photosynthesis process. Light absorption by chlorophyll is inefficient; only a few photons are absorbed by a chlorophyll molecule in a leaf under normal conditions. By employing the enhancement provided by semicontinuous metal films and by microcavities coated with the films one can dramatically increase the efficiency of photosynthesis, as well other photobiological and photochemical processes. The intense local optical intensity in the hot spots promotes chemical reactions and biological processes, allowing single- and multi-photon reactions and processes to proceed at sufficient large rates even at relatively low incident light intensities.

Enhancement of photochemistry and photobiology can be even greater when a semicontinuous metal film is deposited on the internal surface of a highly porous dielectric matrix. An example of such matrix material is zeolites, which typically have porous of sizes from 10 to 100,000 nm, so that the effective internal surface can be as large as 10 m² for a zeolite of volume of 1 cm³. The semicontinuous metal film can be deposited on the internal surface of a zeolite by various methods of chemical deposition, e.g., ion exchange method is used for this purpose. V. Petranovskii, et al., Complex Mediums II: Beyond Linear Isotropic Dielectrics, SPIE Proc. 4467, p. 377 (2001). Semicontinuous metal films on the internal surface of highly porous dielectric matrix enhance photochemistry and photobiology reactions of gaseous and liquid reagents located in the porous of the matrix.

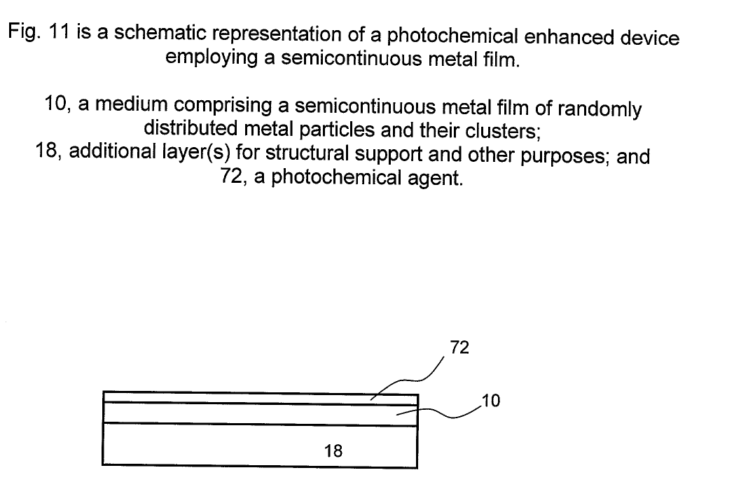

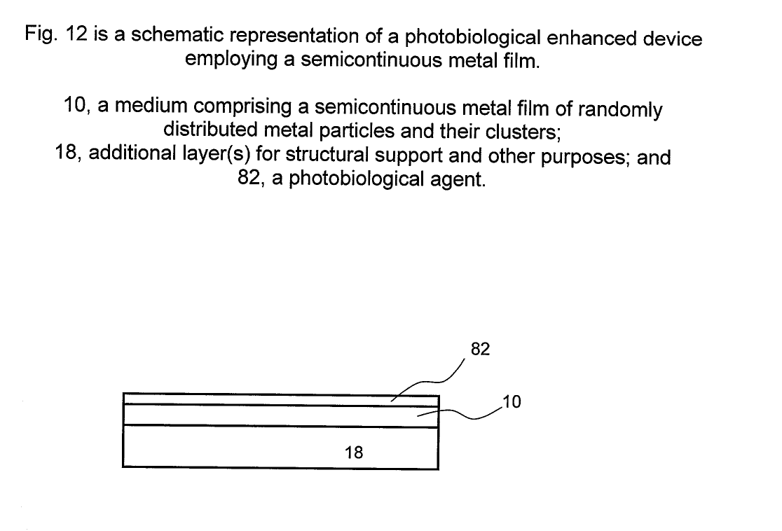

FIGS. 11 and 12 illustrate photochemical and photobiological enhanced devices employing a semincontinuous film according to the invention, respectively. The devices preferably comprise a medium 10 comprising a semicontinuous metal film of randomly distributed metal particles and their clusters, an additional layer 18 for structural support and other purposes, and a photochemical agent 72 or a photobiological agent 82.

### EXAMPLE 8

Generation of Attosecond Pulses

Semicontinuous metal films or semicontinuous-metal-film/microcavity composites can be used for generation of ultra-short pulses with pulse duration shorter than a light cycle, including sub-femtosecond or attosecond pulses. This is possible because of the extremely broad spectrum of the normal modes (eigenmodes) in a semicontinuous metal film. These modes cover a spectral range from the near-ultraviolet to the mid-infrared. The sub-femtosecond pulses can be locally produced in the nanometer-sized hot spots, using excitation pulses that have a broad spectral range. The excitation pulses with the pulse duration in the range between 1 to 1000 femtoseconds can excite modes in a semicontinuous metal film over a broader spectral range. This can occur because the spectral wings of the excitation pulse can excite the modes with much larger enhancement so that the resultant spectrum of the radiating modes can be broader than the spectrum of the excitation pulse. As a result, the local field intensity in the hot spots can experience sub-femtosecond fluctuations. These fluctuations can be detected by using a near-field scanning optical method. Another possible means of the local excitation of sub-femtosecond pulses is to use the white light, which is a supercontinuum of incoherent modes in a very broad spectral range, including the visible and infrared parts of the spectrum. The white light can be generated in a large variety of materials by using femtosecond pulses. When irradiated with the white light, modes from a very broad spectral range are excited on a semicontinuous metal film. The mode self-phasing that can occur in this case results in attosecond fluctuations in the hot spots.

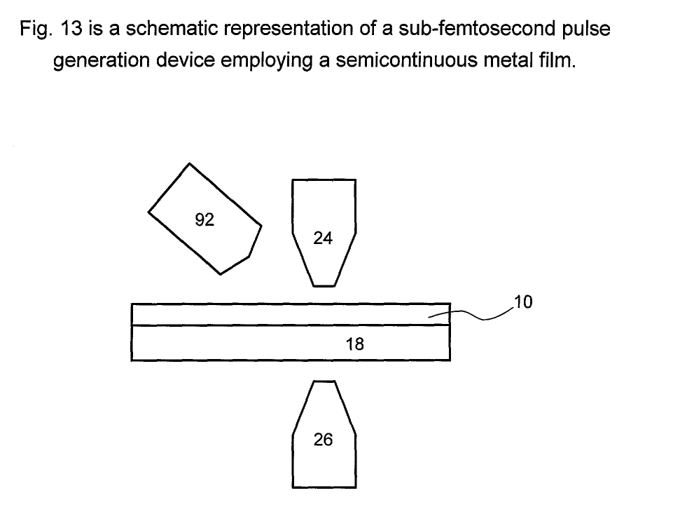

FIG. 13 illustrates a sub-femtosecond pulse generation device employing a semicontinuous metal film according to the invention. The device preferably comprises a medium 10 comprising a semicontinuous metal film of randomly distributed metal particles and their clusters, a light source 92 selected from the group of femtosecond pulses and white-light an additional layer 18 for structural support and other purposes, and one or more near-field detectors 24 located on the same side of the medium as the light source. The device optionally comprises one or more near-field detectors 26 located on the opposite side of the medium from the light source.

The preceding examples can be repeated with similar success by substituting the generically or specifically described reactants and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. An optical enhancing material comprising a medium, said medium comprising a semicontinuous metal film of randomly distributed metal particles and their clusters at approximately their percolation threshold.

2. The material of claim 1 wherein said metal comprises at least one metal selected from the group consisting of silver, gold, copper, platinum, nickel, and aluminum.

3. The material of claim 1 wherein said metal particles have an average width between approximately 1 and 1000 nanometers.

4. The material of claim 1 wherein said metal particles and their clusters have lengths varying from the widths of individual metal particles to a lateral size of the metal film.

5. The material of claim 1 wherein said semicontinuous metal film has an average thickness between approximately 1 and 100 nanometers.

6. The material of claim 1 wherein said semicontinuous metal film has a metal-filling factor p over a range between and p_{c}−(ε_{dielectric}/|εₘₑₜₐₗ|)^{0.36} and p_{c}+(ε_{dielectric}/|εₘₑₜₐₗ|)^{0.36}, where p_{c} is a metal-filling factor at the percolation threshold, ε_{dielectric} is a dielectric function, permittivity, of a dielectric component of the semicontinuous metal film, and εₘₑₜₐₗ is a dielectric function, permittivity, of a metal component of the semicontinuous metal film.

7. The material of claim 1 wherein said semicontinuous metal film is manufactured with at least one method selected from the group consisting of ion exchange, thermal evaporation, pulsed laser deposition, laser ablation, electron-beam deposition, ion-beam deposition, sputtering, radio-frequency glow discharge, and lithography.

8. The material of claim 1 wherein said material provides optical enhancement at light wavelengths between approximately 10 and 100,000 nanometers.

9. The material of claim 8 wherein said material provides optical enhancement at light wavelengths between approximately 200 and 20,000 nanometers.

10. The material of claim 1 additionally comprising an analyte placed proximate said medium.

11. The material of claim 10 wherein said analyte comprises at least one analyte selected from the group consisting atoms, molecules, nanocrystals, nanoparticles, and biological materials.

12. The material of claim 10 wherein said analyte is chiral.

13. The material of claim 10 additionally comprising a non-reactive surface coating placed over a component selected from the group consisting of said analyte, said medium, and both.

14. The material of claim 1 additionally comprising a microcavity/microresonator made of one or more materials selected from the group consisting of dielectric and semiconductor materials.

15. The material of claim 14 wherein said microcavity is selected from the group consisting of spheres, deformed spheres, spheroids, rods, and tubes.

16. The material of claim 14 wherein said microcavity is a semiconductor laser cavity.

17. The material of claim 14 wherein said medium is located at one or more surfaces of said microcavity selected from the group consisting of inner and outer surfaces.

18. The material of claim 14 wherein said medium is an integrated component of said microcavity.

19. An optical sensor comprising:
a medium, said medium comprising a semicontinuous metal film of randomly distributed metal particles and their clusters at approximately their percolation threshold;
a light source incident on said medium; and
one or more detectors of light emitted from said medium.

20. The optical sensor of claim 19 wherein said detector detects at least one signal selected from the group consisting of fluorescence, spontaneous emission, Raman scattering, Rayleigh scattering, Brillouin scattering, and nonlinear optical processes selected from the group consisting of stimulated Raman scattering, hyper-Raman scattering, hyper-Rayleigh scattering, multi-photon anti-Stokes emission, harmonic generation, sum-frequency generation, difference-frequency generation, optical parametric processes, multi-photon absorption, three- and four-wave mixing, and phase conjugation.

21. The optical sensor of claim 19 additionally comprising a microcavity/microresonator.

22. An optical sensing method comprising the steps of:
providing a doped medium, the medium comprising a semicontinuous metal film of randomly distributed metal particles and their clusters at approximately their percolation threshold;
locating the doped medium proximate a medium;
exciting the doped medium with a light source; and
detecting light emitted from said doped medium.

23. The optical sensing method of claim 22 wherein said detecting step comprises detecting at least one signal selected from the group consisting of fluorescence, spontaneous emission, Raman scattering, Rayleigh scattering, Brillouin scattering, and nonlinear optical processes selected from the group consisting of stimulated Raman scattering, multi-photon anti-Stokes emission, hyper-Raman scattering, hyper-Rayleigh scattering, harmonic generation, sum-frequency generation, difference-frequency generation, optical parametric processes, multi-photon absorption, three- and four-wave mixing, and phase conjugation.

24. The optical sensing method of claim 22 additionally comprising the step of employing a microcavity/microresonator.

25. A method of detecting an analyte material, the method comprising the steps of:
exciting both the analyte material and a medium in a vicinity of the analyte material, the medium comprising a semicontinuous metal film of randomly distributed metal particles and their clusters at approximately their percolation threshold, with at least one light source; and
detecting light emitted from the material and medium.

26. The method of claim 25 wherein said detecting step comprises detecting at least one signal selected from the group consisting of fluorescence, spontaneous emission, Raman scattering, Rayleigh scattering, Brillouin scattering, and nonlinear optical processes selected from the group consisting of stimulated Raman scattering, multi-photon anti-Stokes emission, hyper-Raman scattering, hyper-Rayleigh scattering, harmonic generation, sum-frequency generation, difference-frequency generation, optical parametric processes, multi-photon absorption, three- and four-wave mixing, and phase conjugation.

27. The method of claim 25 additionally comprising the step of employing a microcavity/microresonator.

28. The method of claim 25 wherein the analyte material is selected from the group consisting of atoms; molecules; nanoparticles; chemical agents in water and atmosphere; biological agents in water and atmosphere; contaminations and environment hazards in the air, in water, in soil, at or near manufacturing sites, or at waste dumps; explosives; controlled substances; residual chemicals in foods; food poison; and chemical and biological agents in a body, bodily fluids, and wastes of humans and animals.

29. The method of claim 28 additionally wherein said molecules comprise chiral molecules.

30. A gratingless spectrometer comprising:
a medium, said medium comprising a semicontinuous metal film of randomly distributed metal particles and their clusters at approximately their percolation threshold;
a light source incident on said medium; and
one or more near-field detectors of light emitted from said medium.

31. A gratingless spectroscopy method comprising the steps of:
providing a medium, the medium comprising a semicontinuous metal film of randomly distributed metal particles and their clusters at approximately their percolation threshold;
exciting the medium with a light source; and
detecting light emitted from said doped medium in the near-field zone.

32. A device for cryptography, coding and decoding information, said device comprising:
a medium, said medium comprising a semicontinuous metal film of randomly distributed metal particles and their clusters at approximately their percolation threshold;
a light source incident on said medium;
one or more near-field detectors of light emitted from said medium; and
a logic component that compares a detected light pattern with an expected pattern.

33. A method for cryptography, coding and decoding information, the method comprising the steps of:
providing a medium, the medium comprising a semicontinuous metal film of randomly distributed metal particles and their clusters at approximately their percolation threshold;
exciting the medium with a light source;
detecting light emitted from said medium in the near-field zone; and
comparing a detected light pattern with an expected pattern.

34. An enhanced optical limiting material comprising:
a medium, said medium comprising a semicontinuous metal film of randomly distributed metal particles and their clusters at approximately their percolation threshold; and
an optical limiting material placed proximate the medium.

35. An enhanced optical limiting device comprising:
a medium, said medium comprising a semicontinuous metal film of randomly distributed metal particles and their clusters at approximately their percolation threshold; and
an optical limiting material placed proximate the medium.

36. A microlaser comprising:
a medium, said medium comprising a semicontinuous metal film of randomly distributed metal particles and their clusters at approximately their percolation threshold;
an optically active material;
an energy source applied to said medium and said optically active material; and
a microcavity.

37. An optical amplifier comprising:
a medium, said medium comprising a semicontinuous metal film of randomly distributed metal particles and their clusters at approximately their percolation threshold; and
a light source incident on said medium.

38. The optical amplifier of claim 37 additionally comprising a layer of coating material selected from the group consisting of molecules, nanocrystals, and nanoparticles placed proximate said medium.

39. The optical amplifier of claim 37 additionally comprising a microcavity/microresonator.

40. An optical amplification method comprising the steps of:
providing a medium, the medium comprising a semicontinuous metal film of randomly distributed metal particles and their clusters at approximately their percolation threshold;
providing an input signal; and
exciting the medium with a light source.

41. The optical amplification method of claim 40 additionally comprising the step of providing a layer of coating material selected from the group consisting of molecules, nanocrystals, and nanoparticles placed proximate the medium.

42. The optical amplification method of claim 40 additionally comprising the step of providing a microcavity/microresonator.

43. An optical switch comprising:
a medium, said medium comprising a semicontinuous metal film of randomly distributed metal particles and their clusters at approximately their percolation threshold; and
a light source incident on said medium.

44. The optical switch of claim 43 additionally comprising a layer of optical switching material selected from the group consisting of molecules, nanocrystals, and nanoparticles placed proximate the medium.

45. The optical switch of claim 43 additionally comprising a microcavity/microresonator.

46. An optical switching method comprising the steps of:
providing a medium, the medium comprising a semicontinuous metal film of randomly distributed metal particles and their clusters at approximately their percolation threshold;
providing an input signal; and
exciting the medium with a light source.

47. The optical switching method of claim 46 additionally comprising the step of providing a layer of coating material selected from the group consisting molecules, nanocrystals, and nanoparticles placed proximate the medium.

48. The optical switching method of claim 46 additionally comprising the step of providing a microcavity/microresonator.

49. A super density optical recording device comprising:
a medium, said medium comprising a semicontinuous metal film of randomly distributed metal particles and their clusters at approximately their percolation threshold;
a layer of photosensitive materials placed proximate said medium;
a light source incident on said medium; and
one or more near-field detectors of light emitted from said medium and said layer of photosensitive materials.

50. A super density optical recording method comprising the steps of:
providing a medium, the medium comprising a semicontinuous metal film of randomly distributed metal particles and their clusters at approximately their percolation threshold;
providing a layer of photosensitive materials placed proximate the medium;
exciting the medium and photosensitive materials with a light source; and
detecting light emitted from said medium and photosensitive materials in a nearfield zone.

51. A photochemical enhancing device comprising:
a medium, said medium comprising a semicontinuous metal film of randomly distributed metal particles and their clusters at approximately their percolation threshold; and
a photochemical agent placed proximate said medium.

52. The device of claim 51 additionally comprising a highly porous dielectric matrix.

53. A photochemical enhancing method comprising the steps of:
providing a medium, the medium comprising a semicontinuous metal film of randomly distributed metal particles and their clusters at approximately their percolation threshold;
providing a photochemical agent placed proximate the medium; and
exciting the medium and photochemical agent with a light source.

54. The device of claim 53 additionally comprising the step of providing a highly porous dielectric matrix.

55. A photobiological enhancing device comprising:
a medium, said medium comprising a semicontinuous metal film of randomly distributed metal particles and their clusters at approximately their percolation threshold; and
a photobiological agent placed proximate said medium.

56. The device of claim 55 additionally comprising a highly porous dielectric matrix.

57. A photobiological enhancing method comprising the steps of:
providing a medium, the medium comprising a semicontinuous metal film of randomly distributed metal particles and their clusters at approximately their percolation threshold;
providing a photobiological agent placed proximate the medium; and
exciting the medium and photobiological agent with a light source.

58. The device of claim 57 additionally comprising the step of providing a highly porous dielectric matrix.

59. A sub-femtosecond pulse generation device comprising:
a medium, said medium comprising a semicontinuous metal film of randomly distributed metal particles and their clusters at approximately their percolation threshold;
a light source, selected from the group of femtosecond pulses and white-light, incident on said medium; and
one or more near-field detectors of light emitted from said medium.

60. A method of generation of sub-femtosecond pulses comprising the steps of:
providing a medium, the medium comprising a semicontinuous metal film of randomly distributed metal particles and their clusters at approximately their percolation threshold;
exciting the medium with a light source selected from the group of femtosecond pulses and white-light;
detecting the sub-femtosecond pulses using one or more near-field detectors.
